(19) United States
(12) Patent Application Publication
(10) Pub. No.: US 2013/0162397 A1
(43) Pub. Date: Jun. 27, 2013

(54) Students dismissal logistics

(71) Applicants: Mario Alberto Cano, Rowlett, TX (US); Arturo Rafael Cano, Rowlett, TX (US)

(72) Inventors: Mario Alberto Cano, Rowlett, TX (US); Arturo Rafael Cano, Rowlett, TX (US)

(21) Appl. No.: 13/719,429

(22) Filed: Dec. 19, 2012

Related U.S. Application Data
(60) Provisional application No. 61/578,776, filed on Dec. 21, 2011.

(51) Int. Cl. G08B 5/36

(52) U.S. Cl. CPC G08B 5/36
USPC 340/7.55

(57) ABSTRACT

The present invention relates to a method and system to reduce the students dismissal time procedure from schools and daycare facilities using a previously assigned ID tag (RFID, bar-code, etc) located at the student's transport, tag reader to read the ID tag, computer software which processes the ID tag information with the student-transport database already stored to send a notification to the student's waiting area when their transports have arrived and where they are located, also some safety measures can be optionally added to increase security and verify if the driver is authorized to pick up a specific student and notify parents or legal guardian electronically, (text message, e-mail, etc) when their kids are being picked up and by who.

### CROSS REFERENCE TO RELATED APPLICATION

This application claims the benefit of U.S. Provisional Patent Application No. 61/578,776 filed on Dec. 21, 2011,

### BACKGROUND OF THE INVENTION

The present Invention relates to logistics and safety of students pickup procedure in schools and daycare facilities.

Traffic is a growing problem in daycare facilities when kids are picked up by their parent or authorized person as well as in public and private schools, at dismissal time especially but not limited to large urban areas where schools have hundreds of students with limited parking and pick up area.

When students are being picked up at schools, the traffic flow increases dramatically after school. School buses, carpooling and other vehicles create large lines of traffic waiting for their students to be picked up. Students are usually in the classroom or designated area, waiting for their pick up. Many school systems notify each student when their pick up arrives thus creates more traffic as each student leaves. This procedure is then reported causing a delay in the pickup procedures causing not only parking problems and traffic jams but also causes more pollution from idle engines.

Besides all traffic issues already mentioned, another important factor is the student safety. When student's transports are located at school parking lot or pickup area another student's way to their transport may be blocked creating for those students an unsafe way to their transport.

As the whole dismissal and pickup procedure can be confusing and problematic for many school and daycare facilities. Students may mistakenly aboard the wrong transport without realizing it or unauthorized drivers pick up students without permission. It is important to know who is taking the student and verify that the driver has been authorized to pick up the student and save this procedure on data. The fear of student not coming home due to ineffective logistic and safety procedures is an issue that the invention, Students Dismissal Logistics can instantly improve.

### SUMMARY OF THE INVENTION

The disclosed method and system is used to reduce student dismissal times procedure, reduce the student transport waiting time, help to avoid unnecessary traffic and pollution around the schools or daycare facilities meanwhile increasing safety involving the students' dismissal procedure.

The system includes students' grade, and/or waiting area assigned, and student's transport (parent's car, pool car, school bus, etc) database to be stored in data storage, tag reader (radio frequency, bar code, etc), student transport tag (radio frequency, bar code, etc), computer software and screens and/or audio device to notify students.

This method and system works by having the tag reader in a strategically located place at the entrance or nearby the school or daycare facility and when the student transport with a readable and already configured tag arrives school, the tag reader reads the student transport tag, then sends the information to the computer software and the software processes the information from data storage and if transport tag is approved it assigns a parking spot to the student transport (if safety option is available for this student the system verifies the driver using the safety measures already configured like password, finger print, etc.) then notifies the student or students about the arrival and the location of their transport storing in database this information for further reference.

### BRIEF DESCRIPTION OF THE DRAWINGS

FIG. 1 is a flowchart describing the software in this Invention.

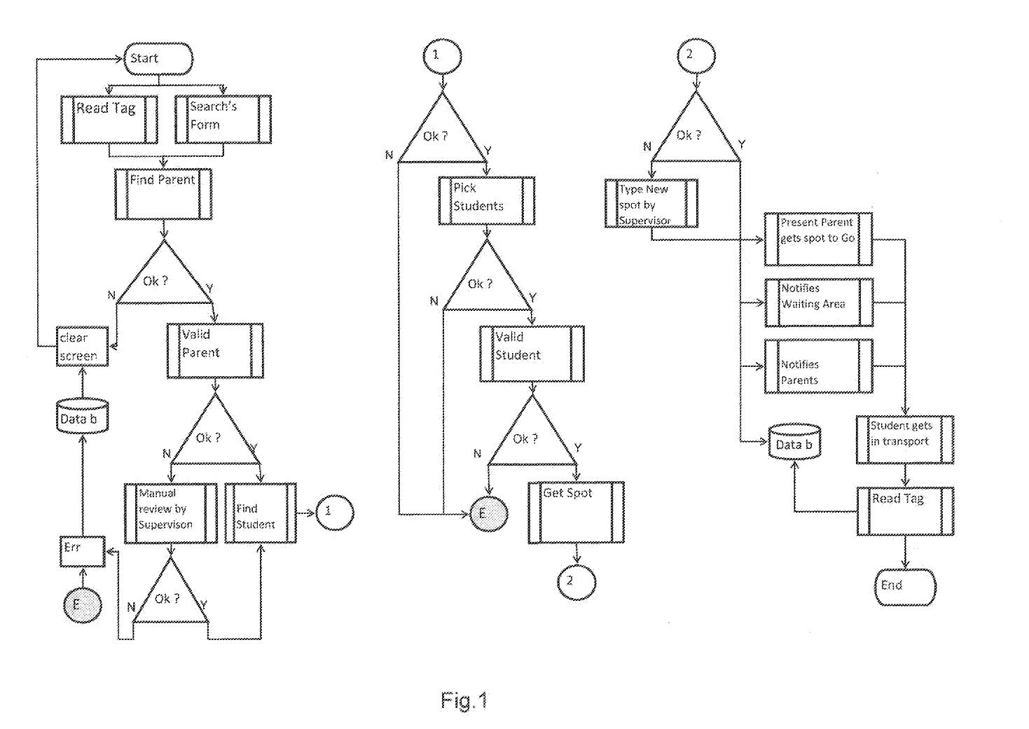

FIG. 2 represents a typical use of this method and system, where blank squares represent the rest of the school rooms non related with the function of the invention like offices, restrooms.

### DETAILED DESCRIPTION OF THE INVENTION

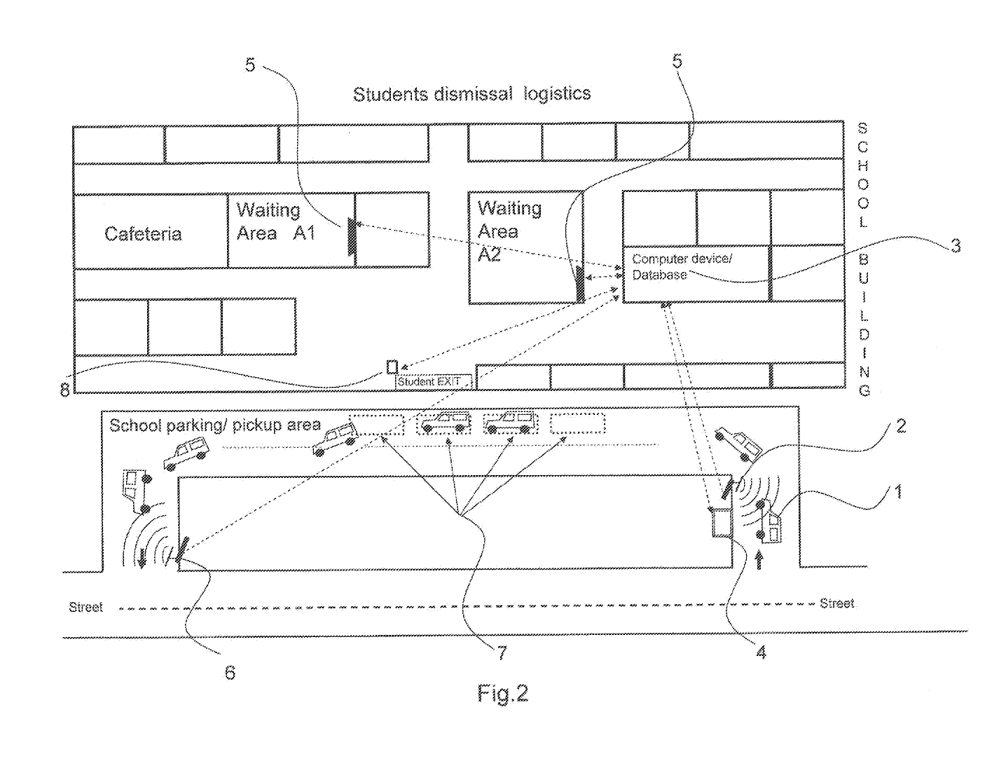

Exemplar embodiments are illustrated in FIG. 2. It is intended that the embodiments and figures disclosed herein are to be considered for illustrative purpose rather than restrictive.

The present Invention provides a method and system to reduce student dismissal procedure time meanwhile increase student safety and save in database all the information acquired during the student dismissal.

The terms “a” and “an” herein do not intend to limit a quantity, but rather refer to the presence of at least one of the referenced items.

Tag and tag reader described in this Invention are but not limited to RFID and bar-code.

Outdoor display described in this Invention is optional and can be interactive or non-interactive depending on the safety priority option, unless otherwise declared.

For the operation of this Invention are necessary a tag in student transport, tag reader at entrance or strategically located at the school or daycare, computer software, database, computer device to run the software, the software paired to the database and to the tag readers available in the school or daycare, an outdoor display, a waiting area or classroom display and a computer device for manually dismiss the students if authorized driver arrive with out tag.

As illustrated in FIG. 2 this method and system works by having a tag reader 2 in a strategically located place at the entrance of the school or daycare facility or nearby and when the student transport with a readable and already configured tag 1 arrives to school, the tag reader reads the student transport tag ,then sends the information to the software 3.

The software processes the information with data storage, checks if tag is approved within the system, if yes continues with the process, otherwise could optionally notify an error to the driver using an outdoor display 4

System checks if student attended school and has not been picked up earlier (status), if student did not attend school or already dismissal notifies driver on the outdoor display 4, otherwise continues with the process.

If safety option is available for this student the system verifies if driver is approved to take this student using the safety keys (password, finger print, face recognition, etc) already configured in the system with the use of the interactive outdoor display 4, if safety keys are denied the driver is notified on the interactive outdoor display 4, otherwise the process continues.

Once the student transport and driver (if applied) have been verified by the system (if optionally available) a parking spot is assigned 7 to driver, otherwise location in parking or pickup area is based on arriving time, then notifies students about the arrival and location of their transport through the display 5 located in their classroom or waiting area assigned. At this step and if selected, the system notifies parents or legal guardian electronically (via text message, e-mail, etc) when their kids are being picked up and by who.

The notification emitted at each waiting area or classroom display can be customized adding sound and pictures to a student's name providing a visual for each student to make it more appropriate for the students and teacher or any school authorized personnel responsible for the area.

Also when two or more student groups are combined at the same waiting area or classroom a particular sound can be played before the name of the student, and a particular picture, design or color can be added to identify a specific student of each group, useful especially, but not limited to young age students.

When students are already in their transport and leaving the school or daycare facility at the exit of the parking area or pick up area another optional tag reader 6 can be added for better time control on the pickup time taken by students' transports.

Manually dismissal can be done by authorized school personnel or authorized driver at student exit in the unlikely case the driver arrive with out tag 8, this should be avoid to take full potential of the system.

What is claimed is:

1. A method for notifying students at school when their transport has arrived comprising:
database for data storage;
a tag attached to the student's transports;
computer device to handle the software;
a tag reader located at entrance or strategically located at school to read the entering transport's tag and send tag data to a computer software;
computer software pair to tag reader to process tag data with database and send notification to the displays; and
display located at classroom or waiting area assigned.

2. The method of clam 1, wherein an outdoor display is used.

3. The method of clam 1, wherein a computer device is used by school authorized personnel to manually dismiss student when authorized driver arrive without tag.

4. The method of clam 1, wherein a computer device is used by authorized driver to manually dismiss student when authorized driver arrive without tag.

5. The method of clam 1, wherein the student's transport is a car.

6. The method of clam 1, wherein the student's transport is a school bus.

7. The method of clam 1, wherein the tag is an RFID tag.

8. The method of clam 1, wherein the tag is a bar-code tag.

9. The method of clam 1, wherein the tag is a magnetic strips tag.

10. The method of clam 1, wherein students is a kid enrolled at the school or daycare.

11. A system for processing the students dismissal comprising:
a computer software;
a database for data storage;
a computer device;
a tag; and
tag reader.

12. The system of clam 11, wherein the tag is an RFID tag.

13. The system of clam 11, wherein the tag is a bar-code tag.

14. The system of clam 11, wherein the tag is a magnetic strips tag.

15. The system of claim 11, wherein students is a kid enrolled at the school.
